(19) United States
(12) Patent Application Publication
(10) Pub. No.: US 2010/0031253 A1
(43) Pub. Date: Feb. 4, 2010

(54) SYSTEM AND METHOD FOR A VIRTUALIZATION INFRASTRUCTURE MANAGEMENT ENVIRONMENT

(75) Inventors: Raymond J. Adams, Plano, TX (US); Bryan E. Stiekes, Brownstown Twp., MI (US)

Correspondence Address: HEWLETT-PACKARD COMPANY;Intellectual Property Administration, 3404 E. Harmony Road, Mail Stop 35, FORT COLLINS, CO, 80528, US

(73) Assignee: Electronic Data Systems Corporation, Plano, TX (US)

(21) Appl. No.: 12/181,743

(22) Filed: Jul. 29, 2008

(51) Int. Cl. G06F 9/455

(52) U.S. Cl. 718/1

(57) ABSTRACT

A secure network architecture. The secure network architecture includes a plurality of data processing system servers connected to communicate with a physical switch block, each of the data processing system servers executing a virtual machine software component. The secure network architecture also includes a data processing system implementing a virtualized logical compartment, connected to communicate with the plurality of data processing system servers via the physical switch block. The virtualized logical compartment includes a plurality of virtual components each corresponding to a different one of the virtual machine components.

### CROSS-REFERENCE TO OTHER APPLICATION

The present application has some Figures or specification text in common with, but is not necessarily otherwise related to, U.S. patent application Ser. No. 11/899,288 for “System and Method for Secure Service Delivery”, filed Sep. 5, 2007, which is hereby incorporated by reference.

### TECHNICAL FIELD

The present disclosure is directed, in general, to data processing system network architectures.

### BACKGROUND OF THE DISCLOSURE

Increasingly, network service providers use common hardware or networks to deliver information and services to multiple different clients. It is important to maintain security between the various clients in the network architecture and service delivery.

### SUMMARY OF THE DISCLOSURE

According to various disclosed embodiments, there is provided a secure network architecture. The secure network architecture includes a plurality of data processing system servers connected to communicate with a physical switch block, each of the data processing system servers executing a virtual machine software component. The secure network architecture also includes a data processing system implementing a virtualized logical compartment, connected to communicate with the plurality of data processing system servers via the physical switch block. The virtualized logical compartment includes a plurality of virtual components each corresponding to a different one of the virtual machine components.

According to another disclosed embodiment, there is provided a secure network architecture that includes a first architecture portion including a plurality of data processing system servers connected to communicate with a physical switch block, each of the data processing system servers executing a virtual machine software component. The secure network architecture also includes a second architecture portion including a plurality of data processing systems each implementing at least one virtualized logical compartment, each connected to communicate with the plurality of data processing system servers via the physical switch block. Each virtualized logical compartment includes a plurality of virtual components each corresponding to a different one of the virtual machine components. The secure network architecture also includes a client interface connected to each data processing system to allow secure client access, over a network, to the virtualized logical compartments. The first architecture portion is isolated from direct client access.

According to another disclosed embodiment, there is provided a method for providing services in secure network architecture. The method includes executing a virtual machine software component on each of a plurality of data processing system servers connected to communicate with a physical switch block. The method also includes implementing a virtualized logical compartment in a data processing system connected to communicate with the plurality of data processing system servers via the physical switch block. The virtualized logical compartment includes a plurality of virtual components each corresponding to a different one of the virtual machine components.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 depicts a depicts a block diagram of a data processing system in which an embodiment can be implemented; and

FIG. 2 depicts a secure network architecture in accordance with a disclosed embodiment.

### DETAILED DESCRIPTION

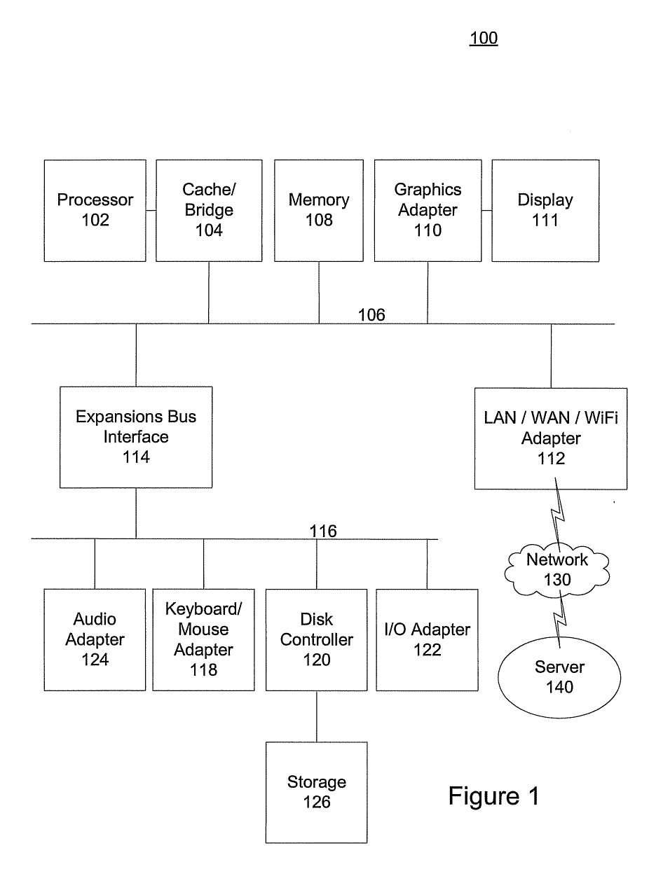

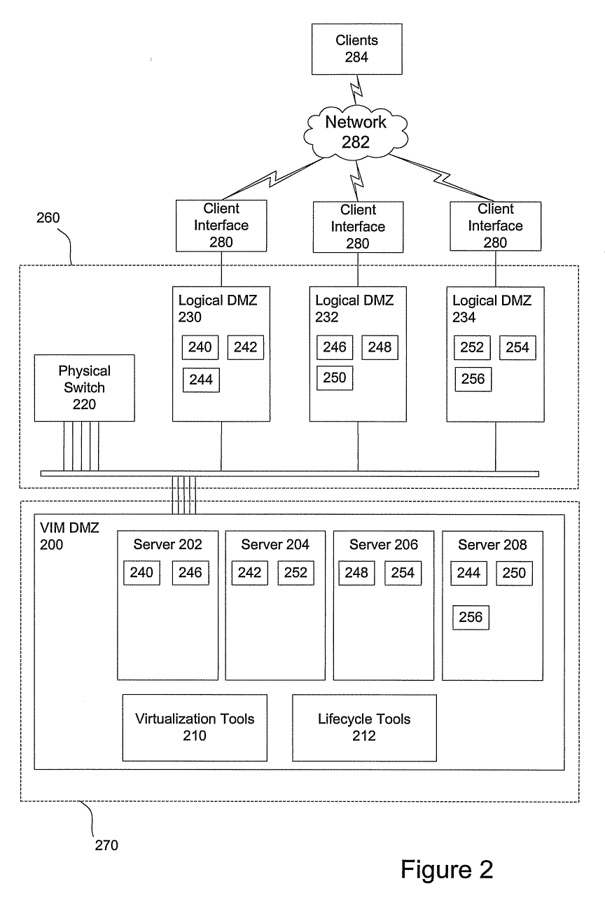

FIGS. 1 through 2, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

Providing a secure network architecture that integrates virtualization technology into it to support multi-tenant solutions has been a desire but has always required compromising on the level of security in order to deliver the functionality. While the virtualization technologies offered means of supporting cross “demilitarized zone” (DMZ) integration into their virtualization technology, using it meant increasing risk of data crossing DMZ security zones.

FIG. 1 depicts a block diagram of a data processing system in which an embodiment can be implemented. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

A Virtualization Infrastructure Management (VIM) environment in accordance with the present disclosure addresses common virtualization issues by taking separating the virtualization technology into two halves. Each of the two halves have their own dedicated copper lines or network ports to connect to their own appropriate DMZs. The below-the-line connections are for the virtualization hosting platforms themselves, and the above-the-line connections are the virtualization consumer applications.

The above the line connections use virtual local-area-network (VLAN) Tagging and Argumentation as a means of supporting virtualization needs in more than one client DMZ while maintaining capacity and high availability for these network connections.

The virtualization technology that is placed within the VIM has specific network routing patterns that help guarantee the integrity and isolation of this secure network.

The present disclosure avoids issues related to separate physical virtualization farms within each DMZ that require virtualization capabilities, and issues related to lowering the security standards of a DMZ and allow data to flow between the DMZ zones.

The disclosed embodiments place the virtualization technology in the same DMZ, allowing a leveraged capability to be at the same security risk level as the guest systems that were consuming it. Lowering the security bar to allow cross DMZ support allows data protection issues.

While a single client can sign off and agree to these increased risks in a single client environment, in a multi-tenant environment there is no single client that can authorize the increased risk for the others within the environment. The disclosed VIM eliminates the additional risks and provides a clean network separation required while not introducing any additional risks.

The virtualization capabilities of the VIM model, according to various embodiments, are divided into two parts: “above the line” use and “below the line” use.

Above the line use, as used herein, refers to the connectivity required by the applications that consume the virtualization (for management, backup, monitoring, access, etc). The above the line architecture portion is a portion of the network architecture that provides services to clients and client systems.

Below the line use, as used herein, refers to the connectivity that the hosts themselves require in order to be managed and supported. The below the line architecture portion is a portion of the network architecture that provides and enables the virtualization functions described herein, and is isolated from clients and client systems.

This separation of connectivity into two distinct parts enables the creation of a security zone around the hosting farms. Without virtualization technology, a host farm can only support a single DMZ. With virtualization technology, host farms can support multiple DMZ's. As long as the virtualization technology is connected to the same physical switch infrastructure, then Cross DMZ and Cross logical compartment use is possible.

The VIM is a marriage of network engineering and virtualization infrastructure. Thus the security limitations of both components limit the breadth of DMZs and compartments supported. The primary limiting factors today are that the network devices must maintain a physical separation at a high level physical switch structure level between compartment types. Therefore, each conventional VIM will also be limited to what it can support based on that same limitation.

FIG. 2 depicts a secure network architecture in accordance with a disclosed embodiment. FIG. 2 illustrates the creation of these separate DMZs and can be utilized to support multiple DMZs from single virtualization farms. This figure shows a VIM DMZ 200 server farm, including server 202, server 204, server 206, and server 208. Each of these servers may support a virtual component such as a conventional and commercially-available software package, including packages such as the VMware, Solaris, Oracle VM, Sun xVM, MS Virtual Server, SUN LDOMS, Oracle Grid, DB2, and SQL Server software systems, for providing various services to clients 284.

Each of the servers 202, 204, 206, 208 in VIM DMS 200 is connected to communicate with a physical switch block 220.

Also connected to the physical switch block 220 are virtualized logical DMZ compartments 230, 232, and 234, each of which can be implemented using one or more data processing systems such as data processing system 100, or more than one virtualized logical DMZ compartment can be implemented on a single data processing system. The disclosed embodiments provide a secure data network (SDN). The SDN divides the network into compartments and sub-compartments or DMZ's. The disclosed VIM maintains the integrity of the SDN by aligning the VIM Network to the same foundational engineering of the SDN itself. This implements a VIM DMZ 200 per physical switch block (PSB) 220 with a network device that separates the host from consumption use of the virtualization technologies.

The VIM also addresses client compartment requirements, providing the same increased security that allowed for lower cost implementations and higher utilization of the technology while eliminating many of the risks encountered in implementing virtualization hosting across DMZ zones. The virtual components and data associated with the virtual components are logically separated from other virtualized logical compartments and other virtual components.

In conventional systems, the various farms of virtual machine servers must be placed in each sub-compartment DMZ of the SDN. This increases equipment costs, reduces leveraging, and requires additional administration costs due to the increased equipment requirements.

In contrast, the disclosed VIM allows for leveraging of the various farms of virtualization for more utilization across the compartments of the SDN and client compartments. This is accomplished by providing virtualized logical DMZ compartments 230, 232, and 234.

Each of the virtualized logical DMZ compartments 230, 232, and 234 can have virtual instances of one or more of the software packages supported on servers 202, 204, 206, and 208. For example, in logical DMZ compartment 230, virtual component 240 is actually executing on server 202, virtual component 242 is actually executing on server 204, and virtual component 244 is actually executing on server 208. In logical DMZ compartment 232, virtual component 246 is actually executing on server 202, virtual component 248 is actually executing on server 206, and virtual component 250 is actually executing on server 208. In logical DMZ compartment 234, virtual component 252 is actually executing on server 204, virtual component 254 is actually executing on server 206, and virtual component 256 is actually executing on server 208.

The virtualized logical compartment therefore appears to a client system as if the virtualized logical compartment were the plurality of servers each executing a virtual machine software component. In this way, each logical DMZ component can support virtual components as if the logical DMZ were a physical DMZ server farm with dedicated hardware supporting each component.

Each of the virtualized logical DMZ compartments 230, 232, and 234 (or the data processing systems in which they are implemented) are connected to a respective client interface 280, to communicate with various clients 284 over network 282. The client interface 280 can include any number of conventional networking components, including routers and firewalls. In some disclosed embodiments, service delivery of the virtual components and other services to the clients 284 is accomplished using a secure service delivery network as described in U.S. patent application Ser. No. 11/899,288 for “System and Method for Secure Service Delivery”, filed Sep. 5, 2007, where each of the virtualized logical DMZ compartments 230, 232, and 234 act as a service delivery compartment as described therein. At least one client system can communicate with the virtualized logical compartment via a network connection to the client interface 280.

Note that, although this exemplary illustration shows three logical DMZ compartments and four servers, various implementations can include any number of servers in the VIM DMZ and any number of logical DMZ compartments, as may be required.

The Virtualized Infrastructure Management, in various embodiments, is a combination of network engineering and virtualization capabilities that are attached to a physical switch block to enable virtualization across all DMZs attached to that same switch block.

The VIM DMZ hosts the management interfaces of the physical infrastructure which has been established for the creation of virtual machine instances within this physical infrastructure. This VIM DMZ is not primarily intended to support the management interfaces of the virtual machine instances. However, through the use of virtual networking technologies, an interface on the virtual machine instance within the VIM can be associated with the management or any other of the Service Delivery Network broadcast domains, thus appearing as a “real” interface within that broadcast domain.

“Above the line” portions of the VIM, shown as portion 260, include the physical switch block 220 and the virtualized logical DMZ compartments 230, 232, and 234, as well as any LAN traffic to the client interfaces 280. Above the line functions include Production traffic, both Load Balanced and Non-Load Balanced, Database, and client/guest Mgmt/BUR traffic.

“Below the line” portions of the VIM, shown as portion 270, includes the VIM DMZ 200, servers 202, 204, 206, and 208, and other components such as virtualization tools 210 and lifecycle tools 212. Below the line functions include VIM host traffic such as VIM Mgmt/BUR, cluster heartbeat-interconnect-private-misc and VIM VMotion traffic.

The VIM, in various embodiments, is DMZ that contains the virtual technologies to isolate management of those virtual technologies. Management of those virtual technologies such as VMotion are isolated from any above the line LAN traffic. VIM Mgmt/BUR must communicate to an SDN Tools compartment, and typically cannot communicate via a NAT'd IP address. The VIM DMZ removes the need for NAT, as it separates the above the line and below the line traffic or Client traffic from Management traffic where multiple clients data might be involved.

Each logical DMZ compartment functions as a DMZ that can be individually provisioned to support either a Leveraged Services Compartment (LSC), Service Delivery Compartment (SDC), or dedicated compartment. The VIM compartment provides a capability to manage the physical infrastructure that supports virtual machine instances. These management capabilities include dedicated VLANs for host servers to gain access to DCI services such as administration, monitoring, backup and restore, and lights out console management.

Virtual machine instances, however, can access to these services, excluding console management, through virtual networks. With virtual networking, virtual machines can be networked in the same way as physical machines and complex networks can be built within a single server or across multiple servers. Virtual networks will also provide virtual machine interfaces with access to production broadcast domains within each SDN compartment, allowing these virtual machine interfaces to share address space with server interfaces physically connected to these broadcast domains.

FIG. 2 depicts the above the line and below the line model as well as the Physical Switch Block alignment in accordance with a disclosed embodiment.

The following are various features of various embodiments of the disclosed virtualization technologies that are deployed within the VIM.

Some embodiments include multi-database port connectivity for guests and local zones to connect to database instances. These embodiments provide significant bandwidth because of increased density of workload and high speed access needs, and redundancy for availability. Some embodiments include multiple production port connections (load balanced and non load balanced rails) for guests and local zones.

Some embodiments include explicit production card layout and port assignment by server type to align to production deployment and to support transition planning development and testing. Some embodiments include redundant ports for private rails like Interconnect and clusters to maintain high availability, and to avoid false cluster failures. Some embodiments include server family alignment of port mappings, and card placement for consistent server profiles.

Some embodiments include an SDN network architecture with appropriate defined rails, and SDN placements for the technology going into the VIM, with the approved usage patterns of VLAN tagging as it applies to the network architecture.

Some embodiments include physical (port) separate management/BUR Rail for all servers in VIM. Some embodiments include physically separate rail for data traffic (high speed access) for guests, local zones, and database instances, and physically separate rail (port) Management/BUR Traffic for guest, local zones, and DB Instances. Some embodiments include a physically separate rail for production traffic (load balanced and non-load balanced) for guests and local zones.

Some embodiments include dedicated port(s) for private rails for clusters, interconnects, and virtual machine rails, as well as multi-physical port connectivity to database servers for increased bandwidth and redundancy for availability for the data rail. Some embodiments include dedicated ports for private rails for integration of various virtual machine packages.

The VIM can be used wherever multiple DMZs are required to separate workload pieces into unique security zones, by implementing each security zone as a virtualized logical DMZ compartment. Implementation of the VIM provides huge cost advantages by reducing the number of physical servers required to deliver virtualization, the time it takes to establish them, and reducing the security risks associated with using the technology.

The VIM can also be used wherever a single DMZ or Multiple DMZ per compartment is required to alter the attack foot print service that exists when running virtualization technology within the same DMZ that the virtualization technology would be consumed. This can reduce the expected risk level of an attack on a virtualized hosting platform, which could take down all the virtualized systems running on that virtualized platform.

Virtualization in accordance with disclosed embodiments can save significantly in power, cooling, and overall cost for each environment. SDN use of the VIM in a standard SDN is expected to reduce costs for physical servers by as much as one third, while in other sites the savings is expected to be closer to eighty percent of the projections without using the VIM. Clients that have multiple DMZ's within their compartments are expected to see similar savings as well.

VIM implementation within various development, testing, and integration environments can reduce the number of servers/devices required to deliver virtualization. In those environments virtualization is secure and can be stretched to its maximum potential by allowing client and SDN compartments to leverage a single VIM environment. This configuration mimics a single VIM for an entire SMC utilizing a leveraged hosting environment to support all needs.

Utilizing the VIM for virtualization also enhances the ability to quickly provision virtualized resources to applications in any DMZ supported by the environment with no delays. Capacity issues are significantly reduced as the entire virtualization farm can support any workload as needed.

VIM MGMT/BUR RAIL VLAN: This VLAN will provides access to leveraged management and backup services. Administrative access to the virtualization hosts are accommodated through this VLAN. This VLAN is not for management or backup activities for any virtual machine or database instances. In the VIM DMZ this VLAN provides the capability to manage the physical host servers from virtualization tools that reside within a Tools DMZ. This VLAN is advertised and preferably has SDN addressing.

VIM VM RAIL VLAN: This private VIM DMZ rail is where active virtual machine images move from one host to another. There are various reasons for this movement within the host servers, load balancing and fail-over are the main causes. Virtual Center will communicate to the hosts (across the VIM Management/Bur Rail) that a movement needs to occur then the action will take place on the this VIM VM VLAN rail. It is VM host server to host server communication that occurs on this rail only, therefore this VLAN is not advertised and preferably has private addressing.

VIM Cluster Heartbeat/Interconnect/Misc VLAN RAIL: This VIM VLAN Rail will be used for clustering needs that occur at the host level or interconnects for database grids. Any other communication that has to happen at the host level, not at the virtual host level will use this VLAN within the VIM DMZ, therefore this VLAN is not advertised and preferably has private addressing.

VLAN Tagging: IEEE 802.1Q (also known as VLAN Tagging) was a project in the IEEE 802 standards process to develop a mechanism to allow multiple bridged networks to transparently share the same physical network link without leakage of information between networks (i.e. trunking). IEEE 802.1Q is also the name of the standard issued by this process, and in common usage the name of the encapsulation protocol used to implement this mechanism over Ethernet networks.

VLAN Tagging allows for the multiple VLANs to be configured on the same piece of copper.

An example of an SDN: A physical machine (virtual machine) is physically plugged into a switch with 10 patch cables. One virtual guest may be in the LSC Database subcompartment and need to use that Data VLAN while another virtual guest maybe in the LSC Intranet and also have a Data VLAN, but it would be a separate distinct VLAN, so VLAN tagging takes and differentiates the two Data VLAN connections.

With a virtual machine server using virtual switch tagging, one port group is provisioned on a virtual switch for each VLAN, and then the virtual machine's virtual interface is attached to the port group instead of the virtual switch directly. The virtual switch port group tags all outbound frames and removes tags for all inbound frames. It also ensures that frames on one VLAN do not leak into a different VLAN.

Virtual IP Specifications: A Virtual IP Address (VIP) is not associated with a specific network interface. The main functions of the VIP are to provide redundancy between network interfaces, to float between servers to support clustering, load balancing, or a specific application running on a server, etc.

VIM 802.1Q—Aggregate to Switch for VLAN V-A,B,C-XX: In some embodiments, this is the aggregated trunk link that carries data from each of the virtual machine instances' virtual switch interfaces to the distribution layer switch. This aggregate VLAN trunk will provide virtual machine connections to any LSC, SDC, or dedicated compartment production, load balanced, or data VLANs through use of VLAN 802.1Q tagging at the ESX server virtual access layer switch. In some embodiments, these can be dedicated connections from the physical interface which are plumbed with multiple virtual machine interfaces on the same VLAN.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of a instructions contained within a machine usable medium in any of a variety of forms, and that the present disclosure applies equally regardless of the particular type of instruction or signal bearing medium utilized to actually carry out the distribution. Examples of machine usable or machine readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A secure network architecture, comprising:
a plurality of data processing system servers connected to communicate with a physical switch block, each of the data processing system servers executing a virtual machine software component; and
a data processing system implementing a virtualized logical compartment, connected to communicate with the plurality of data processing system servers via the physical switch block,
wherein the virtualized logical compartment includes a plurality of virtual components each corresponding to a different one of the virtual machine components.

2. The secure network architecture of claim 1, further comprising a client interface connected to the data processing system, wherein at least one client system can communicate with the virtualized logical compartment via a network connection to the client interface.

3. The secure network architecture of claim 1, further comprising a second data processing system implementing a second virtualized logical compartment, connected to communicate with the plurality of data processing system servers via the physical switch block, wherein the second virtualized logical compartment includes a plurality of virtual components each corresponding to a different one of the virtual machine components.

4. The secure network architecture of claim 1, wherein the virtualized logical compartment appears to a client system as if the virtualized logical compartment were the plurality of data processing system servers each executing a virtual machine software component.

5. The secure network architecture of claim 1, wherein the data processing system implements a plurality of virtualized logical compartments, each connected to communicate with the plurality of data processing system servers via the physical switch block, and wherein each virtualized logical compartment is secure from each other virtualized logical compartment.

6. The secure network architecture of claim 1, wherein the virtual components and data associated with the virtual components are logically separated from other virtualized logical compartments.

7. The secure network architecture of claim 1, wherein the virtual components and data associated with the virtual components are logically separated from other virtual components.

8. A secure network architecture, comprising:
a first architecture portion including a plurality of data processing system servers connected to communicate with a physical switch block, each of the data processing system servers executing a virtual machine software component; and
a second architecture portion including a plurality of data processing systems each implementing at least one virtualized logical compartment, each connected to communicate with the plurality of data processing system servers via the physical switch block, wherein each virtualized logical compartment includes a plurality of virtual components each corresponding to a different one of the virtual machine components; and
a client interface connected to each data processing system to allow secure client access, over a network, to the virtualized logical compartments,
wherein the first architecture portion is isolated from direct client access.

9. The secure network architecture of claim 8, wherein the virtualized logical compartment appears to a client system as if the virtualized logical compartment were the plurality of data processing system servers each executing a virtual machine software component.

10. The secure network architecture of claim 8, wherein the data processing system implements a plurality of virtualized logical compartments, each connected to communicate with the plurality of data processing system servers via the physical switch block, and wherein each virtualized logical compartment is secure from each other virtualized logical compartment.

11. The secure network architecture of claim 8, wherein the virtual components and data associated with the virtual components are logically separated from other virtualized logical compartments.

12. The secure network architecture of claim 8, wherein the virtual components and data associated with the virtual components are logically separated from other virtual components.

13. A method for providing services in secure network architecture, comprising:
executing a virtual machine software component on each of a plurality of data processing system servers connected to communicate with a physical switch block; and
implementing a virtualized logical compartment in a data processing system connected to communicate with the plurality of data processing system servers via the physical switch block,
wherein the virtualized logical compartment includes a plurality of virtual components each corresponding to a different one of the virtual machine components.

14. The method of claim 13, further comprising communicating, by the virtualized logical compartment, with a client system via a client interface connected to the data processing system.

15. The method of claim 13, wherein the virtualized logical compartment appears to a client system as if the virtualized logical compartment were the plurality of data processing system servers each executing a virtual machine software component.

16. The method of claim 13, further comprising implementing a plurality of virtualized logical compartments in the data processing system, each connected to communicate with the plurality of data processing system servers via the physical switch block, and wherein each virtualized logical compartment is secure from each other virtualized logical compartment.

17. The method of claim 13, wherein the virtual components and data associated with the virtual components are logically separated from other virtualized logical compartments.

18. The method of claim 13, wherein the virtual components and data associated with the virtual components are logically separated from other virtual components.
